(19) United States
(12) Patent Application Publication
(10) Pub. No.: US 2006/0090139 A1
(43) Pub. Date: Apr. 27, 2006

(54) Collection view objects for displaying data collection items in user interface elements

(75) Inventors: David J. Jenni, Sammamish, WA (US); Mark D. Harper, Redmond, WA (US); Namita Gupta, Seattle, WA (US); Samuel W. Bent, Bellevue, WA (US)

Correspondence Address: LAW OFFICES OF ALBERT S. MICHALIK;C/O MICROSOFT CORPORATION, 704 - 228TH AVENUE NE, SUITE 193, SAMMAMISH, WA, 98074, US

(73) Assignee: Microsoft Corporation, Redmond, WA (US)

(21) Appl. No.: 10/971,795

(22) Filed: Oct. 21, 2004

(51) Int. Cl. G06F 17/00; G06F 17/21; G06F 7/00

(52) U.S. Cl. 715/760; 715/513; 715/530; 715/764; 707/7

(57) ABSTRACT

Described are collection view objects, which provide a user interface view over a data collection, where each view may have its own sort order, filter and/or grouping criteria, as well as current item semantics. A user interface element is bound to a data collection, such as via markup language (e.g., XAML). At runtime, a collection view object is instantiated as an indirection between the data collection and the user interface element, whereby a collection of data items is viewed according to how each collection view object is currently configured with respect to sorting, filtering and/or grouping. Multiple collection views may be specified on the same data collection, whereby distinct simultaneous views of the data items may be presented in different user interface elements. The collection view object dynamically updates the displayed data as changes are made in the data collection. A current item may be selected within the collection view.

### CROSS-REFERENCE TO RELATED APPLICATION

The present invention is related to U.S. patent application Ser. No.______, entitled “Data Source Objects for Producing Collections of Data Items,” filed concurrently herewith, assigned to the assignee of the present invention and hereby incorporated by reference in its entirety.

### FIELD OF THE INVENTION

The invention relates generally to computer programs and data, and more particularly to displaying computer program data that is maintained as a collection.

### BACKGROUND

Contemporary programming models allow application designers to construct user interfaces via markup language programming. For example, XAML (eXtensible Application Markup Language) is Microsoft® Corporation's relatively new XML-based declarative markup language, which is generally designed to separate presentation layer code from much of the application program logic and thereby allow for the rapid development of user interfaces. The XAML model provides tags for arranging text, graphics, buttons and the other user interface controls, where each XAML tag corresponds to a .NET Framework class that when interpreted automatically instantiates a corresponding object. As a result, designing user interfaces for application programs is simply a matter of arranging tags and setting properties associated with the tags, such as size, color and so forth that will control how the object corresponding to the tag appears when instantiated at runtime.

While such a programming model provides significant benefits, application programs organize their data in a number of ways that do not intuitively correspond to simple markup language directives. For example, consider a collection of related data items, such as a list of customers or a list of media titles. If all items from a collection are text and are to be shown in a list of text boxes for example, then it is relatively straightforward for a designer to declare that item one should appear in text box one, item two in text box two, and so forth. Note that the framework provides for automatic scrolling, so the designer does not have to be concerned with too many text boxes for the available display area.

However, to be more useful, application programs will desire that their collection data be displayable in a variety of ways. For example, presenting the items of a collection of data in a sorted manner is one thing that users will want, as is seeing only a subset of the data after filtering by some criterion or criteria. At present, because the application program owns the data, it is necessary for the application program to take care of filtering and sorting operations, and provide the arranged data to the operating system for display. While in some situations it would be possible for the operating system to make a static copy of the application program's data and then allow the user to sort and filter the copied data using operating system-provided components, such copying is wasteful and may not scale well or even be possible, such as if the application data contained millions of items. Further, not all items are text. Significantly, a data copying model would not work well with dynamic collections of data that have items inserted, modified and deleted while the application program is running.

In sum, programming models are being made available that allow user interfaces to be constructed via relatively easy-to-use markup languages such as XAML. Heretofore, however, a substantial amount of logic and programming skill was needed to manage collections of data in a manner that enables users to interact with that data in useful ways while also dealing with dynamically changing source data. What is needed is a way through straightforward markup language concepts to display collections of (possibly dynamic) data as desired by a user interface designer, while allowing user interaction to manipulate the data as needed by users, without requiring substantial amounts of application program logic to process the data.

### SUMMARY OF THE INVENTION

Briefly, the present invention is directed towards a system and method by which collection view objects provide a view over a data collection, where each view may have its own sort order, filter and/or grouping criteria, as well as current item semantics that allow interaction with the displayed data. A user interface element such as a ListBox control is bound to a data collection, such as in a markup language (e.g., XAML), and at runtime, a collection view object is instantiated between the data collection and the user interface element. The collection view may be specified, named and configured in the markup language, such that a collection of data items is viewed according to how each collection view object is currently configured with respect to sorting, filtering and/or grouping. Multiple collection views may be specified on the same data collection, whereby distinct simultaneous views of the data items may be presented in different user interface elements.

A collection view object facilitates selection of a current item, which corresponds to a selected data item of the data collection that is not filtered out by the collection view. A user or application program can change the current item among those the collection view has not filtered out; navigational commands that change the current item relative to a previously selected item are subject to the sort order of the collection view. The use of a current item facilitates a master/detail view that allows a user or the program to select an item (a master) and automatically see details for that master item.

In one implementation, to use collection views, a user interface designer specifies one or more collection views in markup language in association with a user interface element (corresponding to a tag) and a data collection to which the element is bound, along with any configuration parameters for the collection view such as a name. At runtime, as the markup language is interpreted, a collection view object is instantiated as appropriate for each specified collection view, and bound to the user interface element and specified data collection, (which itself is an object). The collection view object, which may be provided with sorting, filtering and/or other criterion, is queried by a user interface (UI) generation engine that modifies a UI tree of nodes including nodes corresponding to user interface elements. At rendering time, the tree is interpreted, such that the appropriate data of the bound-to collection is displayed. As a result, data items of the data collection are output to corresponding locations in the UI element or elements, as filtered, sorted and/or grouped according to the collection view.

The collection view object dynamically updates the view of the collection data as changes are made in the collection data, including any insertions and deletions, with only events needed to inform the collection view object of the change or changes. The collection view object notifies the UI generation engine about changes, and that engine makes the corresponding modifications to the tree. The collection may be modified on a different thread from the UI/collection view thread. A context affinity object logs change notifications and marshals the change notifications to the UI/collection view thread for processing by the collection view into updates on the display.

The collection view depends on the structure of the underlying data collection. An interface model is provided that includes collection views useful for various data collections, and also provides extensibility which allows applications to be able to create custom collection view classes for different types of collections. For example, in one implementation, collection views are provided for collections which implement IEnumerable, IList and IBindingList interfaces. An ICollectionViewFactory API is provided that applications can use to implement custom collection views to match an underlying data collection.

Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing a data collection in the form of a customer object having data items mapped through a collection view for display in user interface elements, in accordance with various aspects of the present invention;

FIG. 3 is a representation of a data collection having its data items viewed through different collection views, resulting in different outputs to user interface elements, in accordance with various aspects of the present invention;

FIG. 4 is a block diagram generally representing an architecture/framework into which collection views may be instantiated, in accordance with various aspects of the present invention;

FIG. 5 is a representation of a data collection having its data items viewed through different collection views, in which notification events resulting in changed outputs to user interface elements, in accordance with various aspects of the present invention;

FIG. 6 is a representation of a data collection having its data items viewed through different collection views, in which notification events are logged for changing outputs to user interface elements, in accordance with various aspects of the present invention; and

FIGS. 7A and 7B comprise representations of a master detail view that changes based on selection of a current item, in accordance with various aspects of the present invention.

### DETAILED DESCRIPTION

### Exemplary Operating Environment

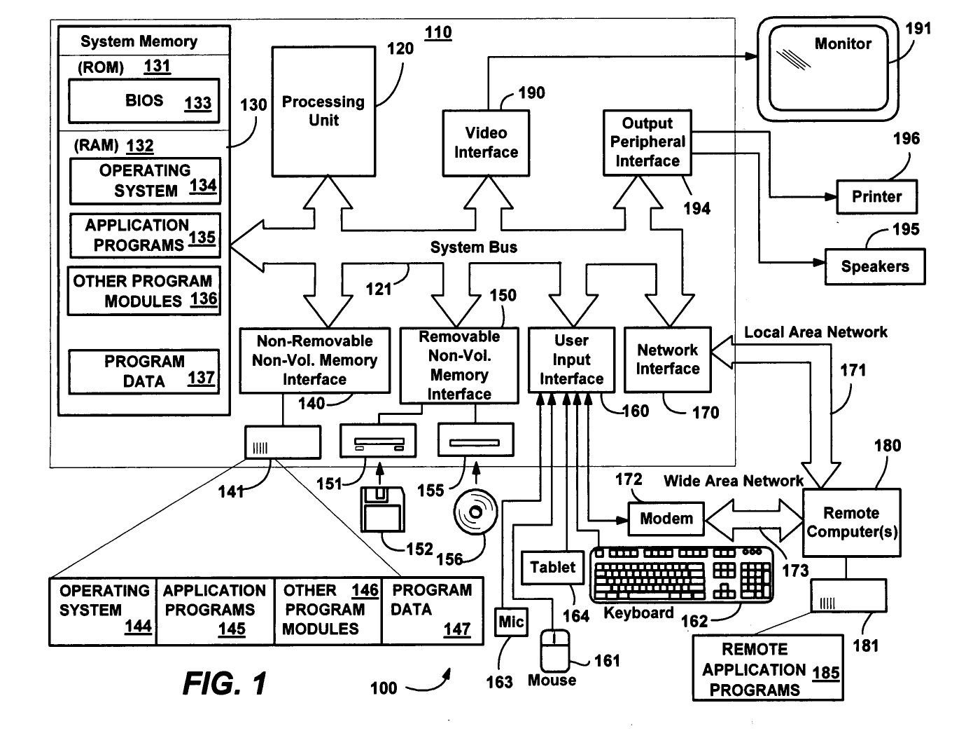

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention includes a general purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136 and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media, discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146 and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies. A user may enter commands and information into the computer 110 through input devices such as a tablet, or electronic digitizer, 164, a microphone 163, a keyboard 162 and pointing device 161, commonly referred to as mouse, trackball or touch pad. Other input devices not shown in FIG. 1 may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. The monitor 191 may also be integrated with a touch-screen panel or the like. Note that the monitor and/or touch screen panel can be physically coupled to a housing in which the computing device 110 is incorporated, such as in a tablet-type personal computer. In addition, computers such as the computing device 110 may also include other peripheral output devices such as speakers 195 and printer 196, which may be connected through an output peripheral interface 194 or the like.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Collection Views

The present invention is generally directed towards a system and method by which items of a data collection are viewed through an indirection that is able to present the data in modified manner relative to its original collection state, e.g., the data items nay be viewed in a sorted, filtered and/or grouped manner. As will be understood, numerous ways to implement the present invention are feasible, and only some of the alternatives are described herein. For example, the present invention is described with reference to a collection view object instantiated between a data collection object and UI elements that may be described in XAML (extensible application markup language), however other alternatives are straightforward to implement, e.g., neither XAML nor any markup language is required, nor is an object-based model. Further, while the present invention is generally described with an architecture and framework that significantly simplifies user interface design when compared to conventional UI programming models, the present invention may be implemented in other architectures. As such, the present invention is not limited to any particular examples used herein, but rather may be used various ways that provide benefits and advantages in computing in general.

In XAML, a UI designer uses tags to specify elements such as text control boxes, image control boxes and so forth, and associates each tag with properties such as where the box appears, what colors it has, its font, size and so forth. For a text box, a string may be provided, while for an image a URL to an image file may be provided.

A data binding model is also provided so that a designer does not have to specify each piece of data, but instead can have a text box or the like be associated with a data object. For example, instead of specifying <Text TextContent=“David”/>, a designer might bind a text box to a file object and specify something like <Text TextContent=*Bind(Path=Name)/>, whereby a “Name” property in the file object will indirectly supply the text at runtime. An automatic notification scheme is provided so that if the name changes, the display reflects the change.

Another type of UI element that may be specified in markup is an ItemsControl, which deals with displaying a collection of items. One example of an ItemsControl is a ListBox control, which displays a list of items of a data collection from which the user can select one (or more). For example, an item (a data object) can be shown as text and/or image data among a list of other text and/or image data. In general, when the markup is processed, each of the items of the collection is iterated over and UI generated for that item in the ListBox. If the number of items exceeds the number that can be displayed, a scroll bar is automatically added to the ListBox control.

In accordance with an aspect of the present invention, instead of iterating over the collection, the iteration is performed over a view of that collection. To this end, a collection view is specified by the UI designer, (or is provided by default), and is instantiated as an object that can be considered as being between a collection and the UI element (e.g., ListBox) that displays the data of the collection.

To specify a collection view, such as bound to a ListBox, the UI designer identifies the collection data (e.g., a data collection object previously named as a resource in the markup, such as “Customers”) and binds it to a collection view, typically given an optional name (e.g., View1) as follows:

<ListBox>

ItemSource=“*Bind(DataSource={Customers}; Path=#View1)”/>

A second named collection view (e.g., View2) may be specified in the same way, and as will be described below, may be bound to a different data source or the same data source as in this example:

<ListBox>

ItemSource=“*Bind(DataSource={Customers}; Path=#View2)”/>

Note that in one implementation, if the designer does not specify a collection view, an unnamed, default collection view is automatically provided upon binding to a data source. Note that the application can access the default collection view, sort and filter it and so forth.

As described below, the collection view provides an indirection between the collection and the UI element that among other aspects, allows sorting and filtering of the collection data such that sorted and/or filtered data appears in the UI element rather than the being displayed in the UI element as it is maintained in the collection data object. For example, a simple data collection may contain items {D, B, C, A} which would appear that way if directly connected to a ListBox; however a collection view object that is configured to sort alphabetically ascending presents the data items as {A, B, C, D} in the ListBox. If also configured so as to filter item C, the collection view object instead presents the data items as {A, B, D} in the ListBox. Only the view is changed, and the collection data items {D, B, C, A}, which belong to the application/user, remain unchanged.

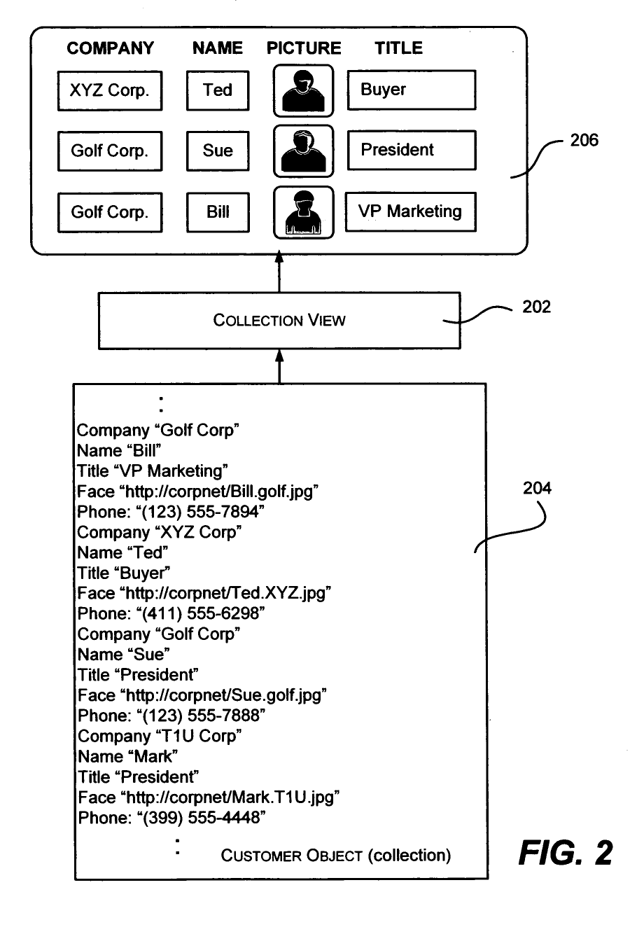

FIG. 2 shows an example of how a collection view object 202 may filter a data collection 204 into a ListBox 206, with some of the data in the data collection (company, name, picture and title) appearing in columns of the ListBox. Note that the ListBox 206 is shown as it might be displayed given a particular collection view object (e.g., descending alphabetically sorted on company, then name). Properties for the ListBox and the text and images will determine whether they will have a surrounding border, as shown.

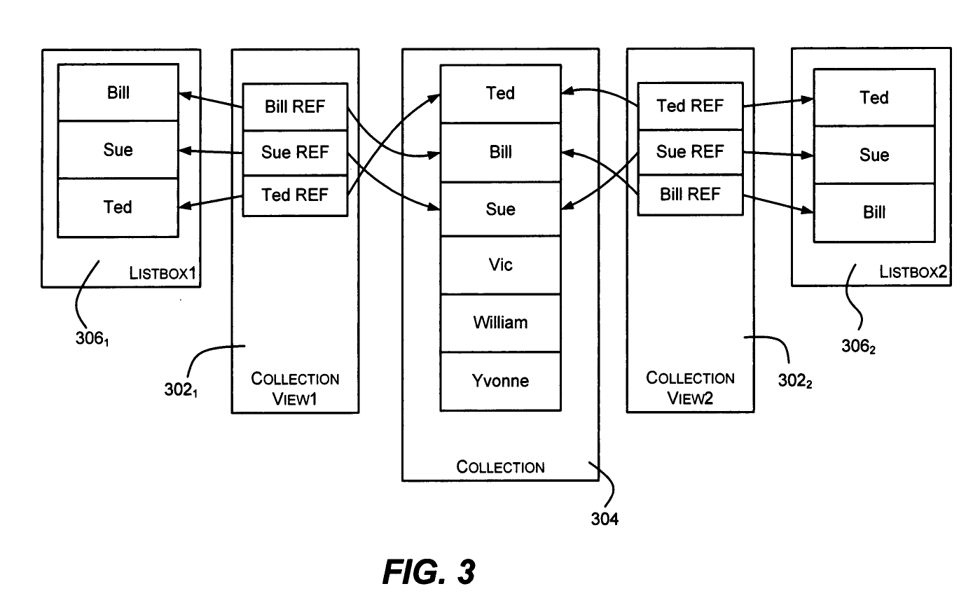

In accordance with an aspect of the present invention, multiple collection view objects may be associated with the same set of collection data. As represented in FIG. 3, there is one data collection 304 containing a set of names, in no particular order. A first collection view object 302₁ sorts the collection data into a first ListBox 306₁ in ascending alphabetical order, while a second collection view object 302₂ sorts the data collection data into a second ListBox 306₂ in descending alphabetical order. Note that both the first ListBox and second ListBox are simultaneously displayable, providing two different views of the same data.

Further, note that the collection views contain references to the collection data rather than a copy of the data itself. As a result, the user may interact with the data and only change the references in the collection view object rather than change the data in the collection. At the same time, if an item in the collection data itself is changed, e.g., “Sue” becomes “Susan” in this example, the collection view will reference the correct data item, and only need adjust (e.g., re-sort) its references as necessary.

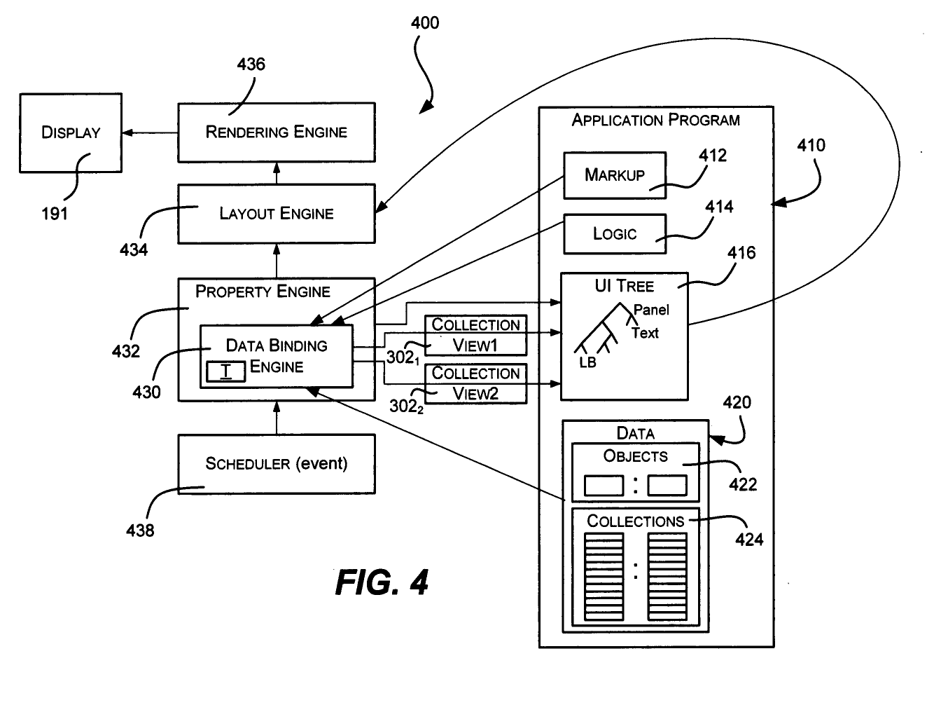

FIG. 4 shows an example architecture and framework 400 into which one or more collection view objects may be implemented. In FIG. 4, an application program 410 contains markup 412 such as XAML and logic 414. In general, at runtime, the markup 412 is interpreted, possibly in conjunction with the logic 414, to construct a hierarchical UI tree 416. For example, the UI tree 416 may contain nodes that represent a panel, some text and a ListBox (LB) along with other nodes. The tree 416 may be built from various data, including data placed directly in the markup 412 and data 420 including collection objects 422 and other data objects 424 that are bound to the application program 410 by a data binding engine 430 of a property engine 432. In general, the data binding engine connects the data objects to the objects in the UI tree 416, while the property engine 432 manipulates the UI objects in the tree 416 such as to keep them updated. Note that the UI tree 410 and data 420 are shown as being part of the application program, but in actuality the UI tree is a section of memory reserved for that particular program and the data may be essentially anywhere, e.g., in memory, in a local or remote database, (or in some combination of these storage entities), and so forth.

In the exemplary architecture and framework 400, a layout engine 434 processes the tree 416, essentially walking the tree to determine the size and position of the objects, and a rendering engine 436 that outputs graphics to the display, such as the monitor 191 of FIG. 1. A scheduler 436 can also cause changes to the display via events.

In keeping with the present invention, one or more collection view objects such as the collection view objects 302₁ and 302₂ of FIG. 3 may be specified in the markup 412 and thereby created by the data binding engine 430, and which are then used to determine the view of a data collection of the application program's one or more collections 424. In general, each collection view object references the data of a collection, and depending on how that collection view object is currently configured, places some or all of the data collection's items into corresponding locations (e.g., ListBoxes) in the UI tree 416. Multiple collection views may be specified, and different collection views may be associated with different data collections, or, as described above with reference to FIG. 3, different collection views may be associated with the same data collection.

To configure the collection view object for sorting and filtering, the designer uses an API referred to as GetNamedView, providing the data source name and collection view name, and then specifies sort parameters for the returned named view, e.g.:
cv=Binding.GetNamedView (Customers, “View1”); cv.sort={new SortDescription(“customerName, ListSortDirection.Ascending)};

Filtering requires application program input, as described below in the example interfaces section. As such to configure filtering, a callback is performed, as follows:
cv.Filter=new(callback . . . ).

As is understood, the user may interact with the data via an input system, not shown, which reports to the application program corresponding input operations performed by the user. The program can then change the configuration as desired, e.g., change the sort description to show the data descending.

Although the collection view objects described above were those that handled lists, other types of collection views are feasible. As long as the collection view object knows how to walk the corresponding collection data, a collection view may be used with essentially any type of data arrangement. Indeed, the concept of collection views is extensible in that programs can create their own customized collection views to match its own data arrangements. To this end, application programs can define their own collection type via an interface named ICollectionViewFactory, as described below in the example interfaces section.

As also described below in the example interfaces section, the framework provides a number of built-in collection views for common types of data structures. Thus, a collection object having an IList interface (as defined by the common language runtime, or CLR)has a corresponding ListCollectionView object, while a defined ArrayListDataCollection data object has an ArrayListDataCollectionView object for dealing with data arrays. If the underlying collection implements an IBindingList interface, then an IBindingListCollectionView is automatically generated for it.

As described above, the collection data may change while a collection view object is instantiated and rendering data. For example, a referenced object in the collection may change its contents, or objects may be added to the collection or deleted from the collection. The collection object fires a change event to the collection view object, in one implementation via an ICollectionChange interface of the collection view object, which then fires its own change event to the UI engine that dynamically updates the display (e.g., the ListBox).

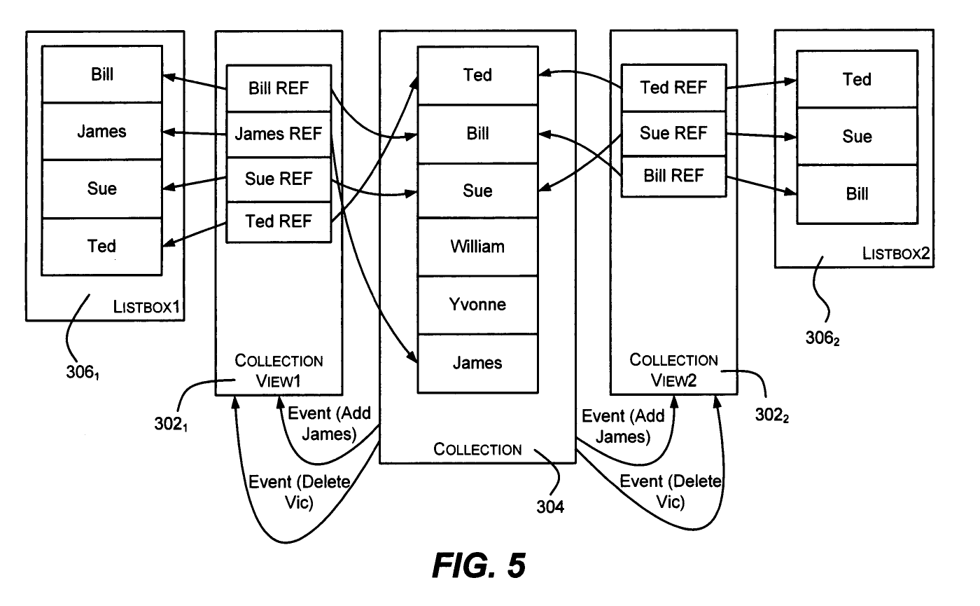

Note that the collection view object receives the event and may or may not update its corresponding display depending on sorting and filtering criteria. For example, FIG. 5 shows the two collection view objects 302₁ and 302₂ of FIG. 3 receiving events from the collection 304, one informing the collection views that “James” has been added to the collection 304 as a name, and the other that the name Vic has been deleted from the collection 304; (these differences in the data collection object 304 are readily apparent from FIG. 3 to FIG. 5).

The first collection view 302₁ is, for example, to sort alphabetically ascending but with a filtering criterion that any name above the letter “U” be excluded. Thus, the collection view 302₁ adjusts based on the addition of “James” because the name meets the filtering criterion, but takes no action with respect to “Vic” because “Vic” was already filtered out. Accordingly, the ListBox 306₁ is updated with James in the correct sort order.

At the same time, the second collection view 302₂ is configured to have a descending sort order, and with filtering criteria that excludes names above the letter “U” and also that excludes any name greater than four letters. Thus, the second collection view object 302₂ takes no action with respect to Vic (because >“U”) nor with James (because >four letters). Note that other data in the collection (not shown in FIG. 5) may be used as filtering criteria, even if that data does not appear in the ListBox. For example, assuming the collection contains such information, the filtering criteria may exclude anyone with sales of less than some user-specified amount, even though the amount of sales need not be displayed in the ListBox.

In accordance with another aspect of the present invention, an application program may choose to make changes to the data collection, such as to add or remove items on a different thread, that is, a worker thread that is not part of the current UIContext. However, the collection view object can only make changes on a privileged UI thread that is part of the current UIContext. To handle this situation, changes are logged and marshaled to the UI thread by an object named UIContextCollectionView. However, the worker thread may be changing quite rapidly, before marshaling can occur. As a result, the view (e.g., in the ListBox) may not be immediately synchronized with the current state of the collection. However, because the changes are logged and processed in order, the view will never be inconsistent with the state of the collection at an earlier time, or at the present time. For example, inserting names into a collection will ultimately change the reference indices in the collection view, but the changes may be faster than can be marshaled to and processed by the collection view. However, by processing the notifications in order, the name change allows the collection view to ensure that the change is made in the correct relative location among the sorted data. Thus, the content of the collection view is synchronized with the notifications, although not necessarily with the current state of the collection data content.

More particularly, in one implementation, when ItemsControl, the typical listener to a CollectionChange, processes the change event, it needs to access the generated UI tree, and thus ItemsControl needs to process the notification on the UIContext. To accommodate this need, the application program may choose to enter the UIContext before changing the data collection, or instead may post the intended collection changes to a thread in the UIContext and defer the change on the collection. These operations require extra work and knowledge from the application program writer.

The common base class for CollectionViews, the UIContextCollectionView (UCCV) class, is aware of the current UIContext and will check if a CollectionChange event received from its associated data collection is already processed on the correct UIContext. If the event source already runs within the UIContext, the UCCV will directly forward the event to its listeners by raising its CollectionChange event.

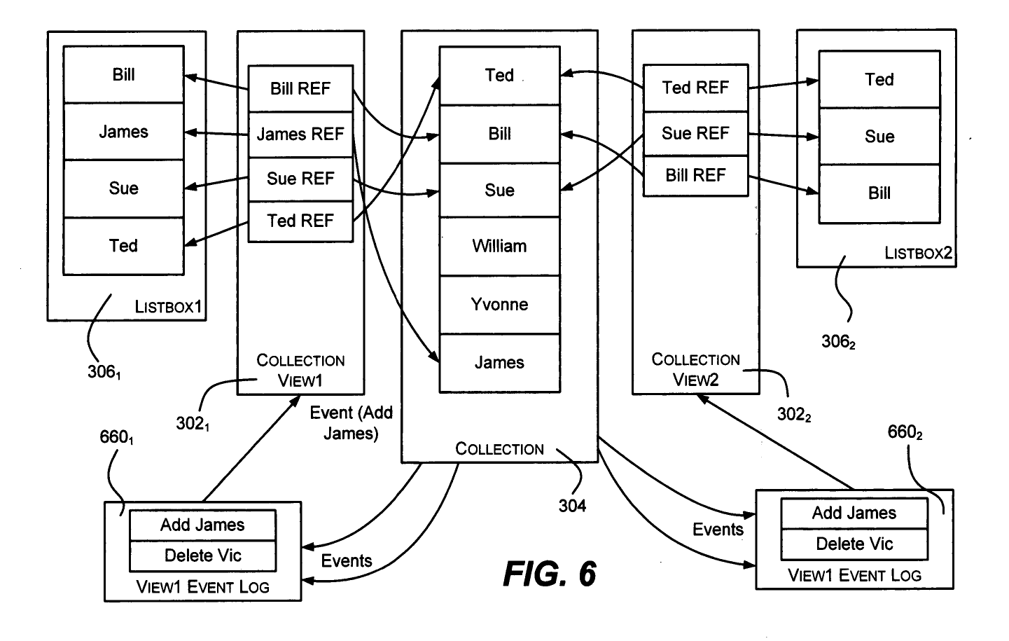

If the event source is not within the current UIContext, the change event argument is added to a protected change log within the UCCV, as represented by the event logs 660₁ and 660₂ in FIG. 6, and the handler posts a ProcessChangeLog invoke delegate to the UIContext's queue and then returns to the event source. Once the ProcessChangeLog delegate is invoked from the correct UIContext, the UCCV will call its protected virtual OnProcessChangeLog method to defer processing of the change log to the concrete subclassed CollectionView. The implementer of the concrete CollectionView is then responsible to process the whole change log and to “replay” the deferred CollectionChange notifications to its listeners with the event arguments corrected to reflect the sorted/filtered view of the collection.

The change log and the associated data collection need to be correctly synchronized across different threads. Both the application and the data binding engine will try to obtain a lock using the value of ICollection.SyncRoot or use the data collection instance itself (if the data collection is only implementing IEnumerable).

A CollectionView client such as the ItemsControl should only access the items in the original collection though the CollectionView (already true with single thread applications) to properly reflect the sorting/filtering. With the deferred firing of CollectionChanged events from the CollectionView, the data collection may have already changed again when the listener processes the CollectionChange in the UIContext.

Efficient collection view implementations lazily create a view cache (or local array) over the actual data collection, but as long as no sorting or filtering is used in the collection view object, the view cache is usually pointing to the original collection. With the deferred notifications, a collection view object implementation will override another virtual method OnCreateViewCache. The UCCV will call this method once after it detects the first CollectionChange outside from the UIContext, giving the collection view object a chance to create its view cache while the data collection is still locked. Note that this callback occurs on the worker thread, not within the UIContext.

To allow layout and inputs to be processed when many collection changes occur, the OnProcessChangeLog yields control after some amount of time, (e.g., 200-500 ms) and post itself a low-priority queue item to continue further processing of the remainder of the change log after the layout engine has had a chance to measure and render.

When a CollectionChangeAction.Refresh is received by the UCCV, any existing change logs will be preempted and the UCCV will give the collection view implementation a chance to create a new view cache candidate.

UIContextCollectionView:

```
public abstract class UIContextCollectionView : CollectionView
{
    protected bool UpdatedOutsideUiContext { get; }
    protected virtual void OnChangePosted(bool refresh);
//OnBeginChangeLogging
    protected virtual ICollection OnProcessChangeLog(ArrayList
changeLog);
// ProcessChangeLog(ArrayList chageLog);
    protected virtual void
OnProcessCollectionChange(CollectionChangeEventArgs args);
//ProcessChangeLogEntry(CollectionChangedEventArgs args);
    protected void ClearChangeLog( );
}
```

In accordance with another aspect of the present invention, the collection view is able to handle a currently selected item (or multiple current selections) among the displayed items in a list. The concept of what is current is per collection view, that is, if a user navigates up or down the list to change the selection, it is the sorted, filtered list of that particular collection view that is navigated, not the source collection data.

An ICurrentItem interface is provided, and includes methods such as MovePrevious, MoveNext, MoveTo and so forth, as set forth in the example interfaces below. Thus, an application UI designer can simply call methods on the ICurrentItem interface in response to user interaction with the listed data items. To let the framework know that a current item is to be selected, the designer may specify in markup, for example, the following:
<Text TextControl=“*Bind(DataSource={Customers} Path=*View1/Name)”/>.

Because a “Name” is specified for display, which corresponds to only a single name even though the collection contains multiple names, it is known that the designer intends to use a current item, that is, a name in this example. Further, note that the current item is based on the first collection view, View1, as identified in the binding information. Thus, the set of data items that can be navigated among to select a current item depends on View1's filtering and sorting information. As is readily apparent, there may be multiple collection views, some or all of which also may be configured to have a current item.

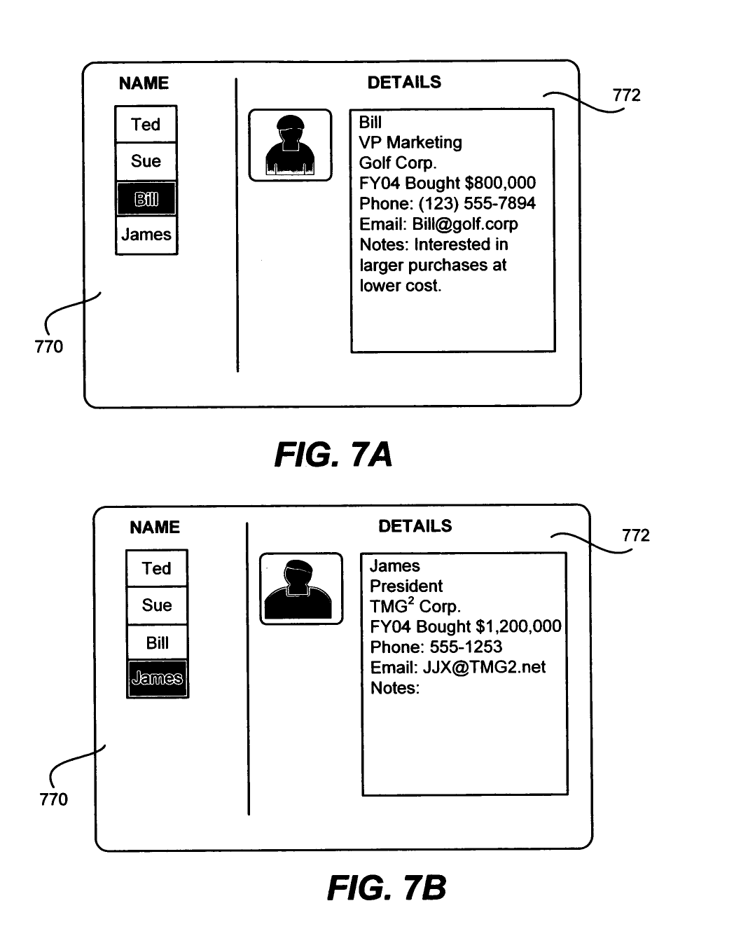

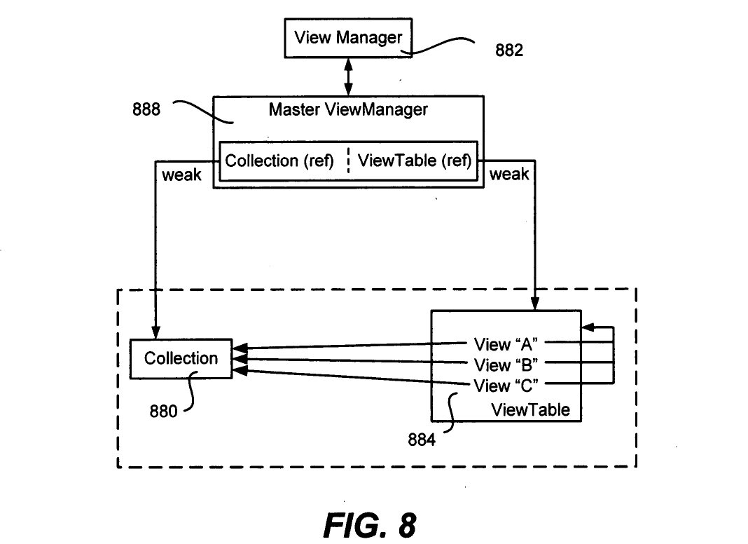

FIGS. 7A and 7B show the concept of current items, along with another concept, referred to as a master/detail view. Note that a current item may be used for other purposes, such as for editing its contents, and not just for the master/detail view exemplified in FIGS. 7A and 7B.

In general, the “master” corresponds to the current item, which is shown in FIG. 7A as the Name item “Bill” via highlighting or another suitable indicator (e.g., set via property data) in an item listing area 770. The details area 772 is another area section of the display, as configured by the UI designer, which corresponds to more detailed information about the currently selected item. In markup, the UI designer specifies what information to show for the current item, which in this example is an image, and additional text (name, title, company, sales data, phone number, email and any notes). In general, this additional data comes from the data collection object, although it is feasible that it comes from another source, e.g., another data object that the data collection object communicates with.

FIG. 7B shows how the details change when the current item is changed, typically by user interaction with the display, but alternatively by another event such as a timed event, or other triggered event (such as caller ID detecting that a customer is calling). In fact, the master information need not be displayed, as the current item (the master) can be changed by the application program without user interaction resulting in the details section being updated. In the example of FIGS. 7A and 7B, the master information is shown in a ListBox in area 770, and as can be seen, the details section 772 automatically updates to match the current item, which is “James” in this example. Further, note that although not shown in FIGS. 7A and 7B, multiple collection views are again possible, and some or all of which may correspond to master/detail arrangements.

Lifetime management of collection views is another consideration, in that any default and named collection views need to be released at some point. To this end, a global table (shown as the block “T” in the data binding engine 430 in FIG. 4) may be maintained by a view manager to map collections and names to collection views. Various algorithms that use information maintained with the collection view object may be used to determine when a collection view is no longer needed.

In general, a collection should not be responsible for managing its own views, because a collection is a data-centric object, while a view (or a set of views) is UI-centric, and thus view management should be handled by UI-related code. A view manager does not modify the collection in any way, nor does it assume that the collection has a reference to the view. As a result, the IDataCollection interface is implemented in a system assembly, where it is visible to third-parties who can then implement their own collection classes without having to know anything about view management. It also allows the creation views over collections that do not implement IDataCollection; e.g., views over an IList (and thus over any Array, ArrayList, and so forth) are supported.

However, this model complicates lifetime management. By way of example, consider that an application program creates views named “A”, “B”, and “C” over a given data collection, and applies a particular sort order to each view. Next, the application program may release its references to view “C”, while keeping references to views “A” and “B and to the collection itself. Then the application program may refer to view “C” again, and will expect that view to still have the same sort order. As is readily appreciated, the view “C” needs to be kept alive as long as the collection itself (or any other view on the collection) is alive.

However, once the application program releases its references to the collection and all of its views, the objects should become eligible for garbage collection. If the collection managed its own views, this would be trivial to implement. With “external” view management, however, the managing entity requires some references to the collection and its views. These references need to be created in such a way that they keep the objects alive as long as necessary, but no longer.

To this end, as generally represented in FIG. 8, for each referenced collection (e.g., the collection 880), a view manager 882 maintains a ViewTable 884, essentially comprising a dictionary that maps names into views for that collection 880. The table 884 contains strong references to the views, and each view has a strong reference to its underlying collection 880. This guarantees that the collection 880 stays alive as long as any view.

The view manager 882 also maintains a master ViewManager 888 comprising a dictionary that maps collections to ViewTables. This is a global table, which cannot contain a strong reference to a collection (because doing so would keep the collection alive forever). Instead, the master ViewManager 888 contains weak references to the collection 880 and to its ViewTable 884. As represented in FIG. 8 by the dashed box surrounding the collection 880 and to its ViewTable 884, the strong references are inside the dashed box; (note that other strong references correspond to the application's references to the collection or its views).

However, because the weak reference stored in the master ViewManager 888 is not enough to keep the ViewTable 884 alive, each view is given a strong reference back to its ViewTable 884, using a ViewManagerData property of a DataCollectionView. These references are represented in FIG. 8 by the arrows from the views back to the right side of the viewtable 884. This adds strong references, and thus keeps the viewtable 884 alive as long as any of the views in it are alive, without affecting garbage collection. Thus when the application program releases its references, the collection and its views can be garbage collected. This will invalidate the weak references in the master ViewManager table 888; the table is occasionally purged of dead references.

### Example Interfaces

ICollectionView

As described above, ICollectionView is an interface that applications that write their own collections can implement to enable current record management, sorting, filtering, grouping and so forth in a custom way:

```
public interface ICollectionView : IEnumerable
    {
        //enables setting the CultureInfo. Sort should use this.
        CultureInfo Culture { get; set; }
        // If the item is Contained in the view (may or may not be
        // in the underlying collection)
        bool Contains (object item);
        //reference to original collection
        IEnumerable Collection { get; }
        //Currency
        ICurrentItem CurrentItem { get; }
        //enumerator
        IEnumerator.GetEnumerator( );  //
        //Grouping
        SortDescription[ ]Group { get; set; }
        bool CanGroup{ get; }
        //filtering
        DataListFilterCallback DataListFilter{ get; set; }
        bool CanFilter { get; }
        //Sorting
        SortDescription[ ] Sort { get; set; }
        bool CanSort { get; }
        //Refresh
        void Refresh( );
        IDisposable DeferRefresh( );
        object ViewManagerData { get; set; }
    }
        public delegate bool DataListFilterCallback(object item);
```

ICurrentItem

ICurrentItem is an interface, which maintains current record semantics and navigation information. CurrentChanging is a cancelable event handler.

| public interface ICurrentItem | |
|---|---|
| { | |
| object | Current {get;} |
| bool | IsAfterLast {get;} |
| bool | IsBeforeFirst {get;} |
| bool | MoveFirst( ); |
| bool | MovePrevious( ); |
| bool | MoveNext( ); |
| bool | MoveLast( ); |
| bool | MoveTo(object item); |
| event | CancelEventHandler CurrentChanging; |
| event | EventHandler CurrentChanged; |
| } | |

When binding a singleton value to a collection, the framework automatically binds to the ‘current item’ of that collection. If viewed in an ItemsControl, the current item can be kept synchronized with the selection and is hence used for master detail scenarios.

Sorting

ICollectionView

```
//Sorting
        SortDescription[ ] Sort { get; set; }
      bool CanSort { get; }
```

Uses a list of SortDescriptions, where each SortDescription defines the property by which to sort as well as the direction in which to sort. The user of the CollectionView provides a list of properties and a direction, and the implementer of the CollectionView sorts the underlying collection by each of the SortDescriptions in the order provided.

Sort Description

Sort Description takes the property name and direction in which to sort.

```
  public struct SortDescription
    {
        public SortDescription(string propertyName, ListSortDirection
direction);
        public static SortDescription[ ] Empty { get; }
        public string PropertyName { get; }
        public ListSortDirection Direction { get; }
    }
```

ListCollectionView (adds an IComparer way of sorting)

//To Compare which item comes first
public virtual IComparer CustomSort{ get; }

The user can provide an instance of IComparer class which provides information about which item should be placed first, given two items. Using this class, the implementer of the CollectionView sorts the underlying collection. Note that setting either the Sort or the CustomSort properties causes the CollectionView to Sort immediately.

Filtering

```
  //filtering
  DataListFilterCallback DataListFilter{ get; set; }
bool CanFilter { get; }
  public delegate bool DataListFilterCallback(object item);
```

ICollectionView provides a DataListFilterCallback which the user of the ICollectionView can implement to tell whether a particular item is in the filtered list or not, given a certain criteria set. The implementer of the ICollectionView uses this to filter the underlying collection. Note that Setting the Filter property forces filtering of the collection.

If the implementer of ICollectionView does not implement this, then it needs to set CanFilter to return false.

Contains

The API “Contains” on the ICollectionView takes an item and indicates whether the given item is contained by the CollectionView or not. This method makes no assumptions about whether the item is already contained in the underlying collection or not.

DeferRefresh

If the user uses DeferRefresh, this API on ICollectionView allows the user of the CollectionView to defer the actual implementation of Sort/Filter/Grouping so that the implementer of the ICollectionView can optimize sorting and/or filtering and/or grouping together instead of doing them one after another.

```
using (cv.DeferRefresh( ))
{
    cv.Sort = new SortDescription(“Name”);
    cv.Filter = myFilterCallback;
}
```

Change Notifications

If the underlying collection implements ICollectionChange, then the CollectionView listens for add/delete/refresh changes. The collection view object checks if the change affects the given view and if so makes the required changes to the view. For example, if an item gets added, collection view object first checks if the given item passes the filter on the collection view, if it does then it places it in the correct position based on the sort order of the collection view object. Similarly for delete, the collection view object will check if the deleted item belongs to the view, and if so, delete it from the view.

When implementing one's own collections and CollectionViews, authors can implement their own CollectionChangeEvents by subclassing the CollectionChangeEvents to provide a hint. The Hint allows the Collection to pass special information to the corresponding CollectionView about the insertion/deletion based on the underlying data structure of the Collection to enable more efficient action by the CollectionView.

```
  public class SpecialCollectionChangedEventArgs :
  CollectionChangedEventArgs
{
        public object Hint { get; }
  }
```

For example, if the underlying collection is index based, then the collection can provide the index of the item added as a hint so that the CollectionView can easily look up the item.

ICollectionViewFactory

A collection can optionally implement ICollectionViewFactory. This interface has a CreateView method which can create a CollectionView. Collections that want to create their own View, and not use the default ListCollectionView based on IList, should implement this interface.

A sample implementation of ICollectionChange and ICollectionViewFactory based on ArrayList, called ArrayListDataCollection is provided, which should satisfy the needs of users with small to moderate data sets. Users may create new implementations of these interfaces based on more complicated or domain-specific data structures of their choice.

View Factory

The framework provides a View Factory that allows application program authors/designers to create a View over a collection on demand. Whenever the author wishes to create a new view over a collection, the author calls into the Binding.GetView( ) method which returns a view corresponding to the collection passed in as a parameter.

```
class Binding {
    public static CollectionView GetDefaultView(IEnumerable
collection);
    public static CollectionView GetNamedView(IEnumerable collection,
string name);
    public static CollectionView GetDefaultView(IListSource
collection);
    public static CollectionView GetNamedView(IListSource collection,
string name);
    public static CollectionView GetCustomView(IEnumerable collection,
string name, Type collectionviewclass);
    public static CollectionView GetCustomView(IListSource collection,
string name, Type collectionviewclass);
}
```

GetDefaultView returns the default view over the collection. Each time the Default view for a given collection is requested, the requester gets the same view back.

GetNamedView returns a named view over the collection. This allows the application program author to have more than one view over the same collection, by passing in a name. Asking for a view with the same name and the same collection will return the same view.

GetCustomView takes a Type parameter that specifies a type derived from ICollectionView, in addition to other parameters, and allows application authors to provide their own class, whose instance they wish the returned CollectionView to be.

The view factory which does the actual work behind Binding.GetCollectionView( ) creates automatic wrappers and proxies if necessary:
1. If the passed-in collection implements ICollectionViewFactory, it calls this interface's CreateView to get a CollectionView.
2. If the passed-in collection does not support the interface, but it implements IList/IEnumerable (e.g., System.Array), the view factory automatically wraps the IList into a ListCollectionView which gives the IList all the CollectionView and ICurrentItem capabilities (current item management, sorting, filtering), but of course cannot supply the CollectionChangeEvent features unless the collection implements ICollectionChange.
3. The factory verifies that the CollectionView derives from UIContextCollectionView. If it does not, the factory wraps the Collection View in a UIContextCollectionViewProxy to enforce context affinity when used by the data binding engine and the UI generator. The built-in CollectionViews already derive from UIContextCollectionView, but a third-party collection view implementation might not.
   The Built in set of CollectionViews

ListCollectionView

For collections implementing IEnumerable and/or IList, a ListCollectionView is automatically created. The ListCollectionView provides the functionality of the ICollectionView, namely sorting, filtering, grouping and CurrentItem, as well as CollectionChange notifications if the underlying collection implements them.

```
public class ListCollectionView : UIContextCollectionView, ICurrentItem,
IList, ICollectionChange
{
    protected ArrayList ShadowCollection { get; set; }
    protected override ICollection
    OnProcessChangeLog(ArrayList changeLog);
}
public sealed class ArrayListCollectionView : ListCollectionView
{
    protected override void
OnProcessCollectionChange(CollectionChangeEventArgs args);
}
```

BindingListCollectionView

If the underlying collection implements IBindingList then an IBindingListCollectionView is automatically generated on top of it. Any filtering/sorting on the BindingListCollectionView is passed on to the corresponding methods on the underlying IBindingList, hence the BindingListCollectionViews on top of an IBindingList will have the same sort/filter order.

```
public sealed class BindingListCollectionView :
UIContextCollectionView, ICurrentItem, IList
{
    public string Filter{get;}
    protected override void OnChangePosted(bool refresh);
    protected override ICollection
    OnProcessChangeLog(ArrayList changeLog);
}
```

ArraylistCollectionView

An ArrayList collection view is implemented based on a collection class and CollectionView which implements these interfaces, so that for the general case, application writers can use it directly.

```
namespace System.Windows.Data
{
    public interface IContains
    {
        bool Contains(object item);
    }
    public sealed class ArrayListDataCollection : ArrayList,
ICollectionChange, ICollectionViewFactory
    {
        public ArrayListDataCollection( );
        public ArrayListDataCollection(int capacity);
        public override int Add(object newItem);
        public override void AddRange(ICollection range);
        public override void Insert(int index, object insertItem);
        public override void InsertRange(int index, ICollection c);
        public override void Remove(object removeItem);
        public override void RemoveAt(int index);
        public override void RemoveRange(int index, int count);
        public override void Clear( );
        public override void Reverse( );
        public override void SetRange(int index, ICollection c);
        public override void Sort( );
        public CollectionView CreateView( );
        public event CollectionChangeEventHandler CollectionChanged;
    }
    public abstract class UIContextCollectionView : CollectionView
    {
        protected UIContextCollectionView(ICollection collection);
        protected UIContext Context { get; }
        protected bool CheckAccess( );
        protected void VerifyAccess( );
    }
    public sealed class ArrayListCollectionView :
ContextAffinityCollectionView, ICurrentItem, IComparer
    {
        public ArrayListCollectionView(ArrayList aldc);
        public override void Refresh( );
        public override int IndexOf(object item);
        public override bool Contains(object item);
        public override IEnumerator GetEnumerator( );
        public bool MoveFirst( );
        public bool MovePrevious( );
        public bool MoveNext( );
        public bool MoveLast( );
        public bool MoveTo(object item);
        public event CancelEventHandler CurrentChanging;
        public event EventHandler CurrentChanged;
        public int Compare(object o1, object o2);
        public override int Count { get; }
        public override SortDescription[ ] Sort { get; set; }
        public override bool CanSort { get; }
        public object Current { get; }
        public bool EOF { get; }
        public bool BOF { get; }
        public IContains CustomFilter { get; set; }
        public IComparer CustomSort { get; set; }
        protected override void OnCollectionChanged(object sender,
CollectionChangeEventArgs args);
    }
}
```

### CONCLUSION

As can be seen from the foregoing detailed description, there is provided a method and system in the form of collection view objects that enable straightforward markup language concepts to display collections of (possibly dynamic) data as desired by a user interface designer. The collection view objects allow data manipulation such as sorting and filtering to manipulate the data as needed by users, without requiring substantial amounts of application program logic to process the data. The present invention thus provides numerous benefits and advantages needed in contemporary computing.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising:
processing information that binds a data collection to a user interface element; and
associating a collection view with the data collection and the user interface element to provide a controllable view of the collection data.

2. The method of claim 1 wherein processing the information comprises interpreting markup language code.

3. The method of claim 1 wherein processing the information comprises interpreting extensible application markup language code (XAML).

4. The method of claim 1 wherein processing the information comprises associating a specified name with the collection view.

5. The method of claim 1 wherein associating the collection view with the data collection and the user interface element comprises instantiating the collection view as an object at runtime.

6. The method of claim 1 further comprising, configuring the collection view to sort the collection data.

7. The method of claim 1 further comprising, configuring the collection view to filter the collection data.

8. The method of claim 1 further comprising, configuring the collection view to filter the collection data into a filtered data subset based on one or more filtering criteria, and configuring the collection view to sort the filtered data.

9. The method of claim 1 further comprising associating another collection view with the data collection and another user interface element to provide another controllable view of the collection data.

10. The method of claim 1 wherein an item of the collection data comprises a current item of the collection view.

11. The method of claim 10 further comprising, changing the current item of the collection view to another item of the collection data, wherein the items in the collection view that can be the current item are a subset of the items in the collection data based on one or more filtering criteria associated with the collection view.

12. The method of claim 10 further comprising, receiving an instruction to change the current item of the collection view to another item, and in response, changing the current item of the collection view to another item of the collection data based on a sort order associated with the collection view.

13. The method of claim 10 wherein the current item corresponds to a master item and further comprising, displaying details related to the master item in a detail view.

14. The method of claim 1 wherein the collection data is changed on a first thread, and further comprising, logging and marshaling a change notification for processing by the collection view on another thread.

15. The method of claim 1 further comprising, receiving notification of a change to the collection data, and further comprising, determining whether the change meets filtering criteria associated with the collection view, and if so, updating the user interface element to reflect the change.

16. The method of claim 15 wherein the notification of the change corresponds to an insert notification, wherein the change is determined to meet the filtering criteria, and wherein comprising, updating the user interface element to reflect the change comprises inserting data into the user interface in a location based on a sort order associated with the collection view.

17. The method of claim 1 wherein the collection view comprises an object, and further comprising, managing the lifetime of the collection view object.

18. At least one computer-readable medium having computer-executable instructions, which when executed performing the method of claim 1.

19. In a computing environment, a system comprising:
a framework including a data binding engine that binds a data collection specified by an application program to an application program-specified element of a user interface; and
a collection view, the collection view coupled to the data collection and the element of the user interface to provide a view of data items of the data collection via the user interface element.

20. The system of claim 19 wherein the data binding engine instantiates the collection view as an object.

21. The system of claim 19 wherein the collection view is coupled to the element via a user interface tree associated with the application program, the collection view queried to write data into the tree at a node corresponding to the element.

22. The system of claim 19 wherein the element comprises a listbox control.

23. The system of claim 19 wherein the element is identified in a tag of a markup language and wherein the data binding engine binds the element to a data collection identified within the tag.

24. The system of claim 23 wherein the collection view is named within the tag.

25. The system of claim 19 wherein associating the collection view with the data collection and the user interface element comprises instantiating the collection view as an object at runtime.

26. The system of claim 19 wherein the collection view sorts the data items to provide the view of the data collection in a sort order.

27. The system of claim 19 wherein the collection view communicates with the application program to filter the data items according to one or more filtering criteria to provide the view as a subset the data collection.

28. The system of claim 19 further comprising another collection view coupled to the data collection and to another user interface element to provide another manageable view of the collection data.

29. The system of claim 19 wherein an item of the collection data comprises a current item of the collection view.

30. The system of claim 29 wherein the current item of the collection view is one item of the data collection mapped by the collection view to a location within the element, and wherein the current item is changed to another item by a move instruction that is relative to that location.

31. The system of claim 30 wherein the current item is changed by the move instruction based on a sort order associated with the collection view.

32. The system of claim 19 wherein the one item of the collection is a master item, and further comprising at least one other element of the user interface in which the collection view displays details related to the master item.

33. The system of claim 19 further comprising a log in which change notifications corresponding to changes to the data collection are logged for processing by the collection view.

34. The system of claim 19 wherein the collection view comprises an object, and further comprising a view manager that manages the lifetime of the collection view object.

35. At least one computer-readable medium having computer-executable instructions, which when executed perform steps, comprising:
processing markup language, the markup language including a tag for a user interface element and a reference to a data collection to be bound to the user interface element; and
instantiating a collection view object, the collection view object logically between the data collection and the user interface element to map which data items of the data collection are displayed at one or more locations in the user interface element.

36. The computer-readable medium of claim 35 further comprising sorting the data items such that the collection view object maps the data items of the data collection to the one or more locations in the user interface element based on a sort order.

37. The computer-readable medium of claim 35 further comprising filtering the data items such that the collection view object maps a subset of the data items of the data collection to the one or more locations in the user interface element based on at least one filtering criterion.

38. The computer-readable medium of claim 35 further comprising selecting a data item as a current item.

39. The computer-readable medium of claim 38 further comprising changing information displayed in the user interface element based on the current item.

40. The computer-readable medium of claim 38 further comprising changing information displayed in another user interface element based on the current item.

41. The computer-readable medium of claim 35 further comprising instantiating another collection view object, the other collection view object logically between the data collection and another user interface element to map which data items of the data collection are displayed at one or more locations in the other user interface element.

42. The computer-readable medium of claim 35 wherein the data collection is changed, and further comprising, remapping which data items of the data collection are displayed in the user interface element in response to the changed data collection.

43. The computer-readable medium of claim 35 further comprising managing the lifetime of the collection view object.
